(19) United States
(12) Patent Application Publication
(10) Pub. No.: US 2013/0326989 A1
(43) Pub. Date: Dec. 12, 2013

(54) Wooden Floor Tile With Milled Surface

(71) Applicants: Ian David Hartert, Nashville, TN (US); Kevin Scott Russell, Nashville, TN (US)

(72) Inventors: Ian David Hartert, Nashville, TN (US); Kevin Scott Russell, Nashville, TN (US)

(21) Appl. No.: 13/492,199

(22) Filed: Jun. 8, 2012

(51) Int. Cl. E04B 5/00; B27M 3/04

(52) U.S. Cl. 52/578; 144/371

(57) ABSTRACT

Wooden tiles are disclosed having a top surface that is milled to produce multiple individual planks from a single individual tile. The tiles are configured such that when laid adjacent to one another on a surface, the pattern defined by the individual planks repeats. In one arrangement the tiles are milled on a CNC machine that allows for producing planks having non-linear edges.

### FIELD

The present application is directed to wooden flooring tiles. More specifically, the present application is directed to wooden flowing tiles having an milled surface to provide the appearance of being a composite of multiple individual wood planks.

### BACKGROUND

Harwood flooring is commonly utilized in residential and commercial settings. However, previous hardwood flooring systems have suffered various drawbacks. For instance, most previous hardwood flooring systems utilize linear planks of wood that are fit together to form a continuous hardwood floor. Such planks provide difficulty in some applications. For instance, such planks typically vary in length from a few feet to upwards of eight feet in length. Accordingly, transport of such planks into, for instance, high-rise buildings becomes difficult. Furthermore, most solid hardwood flooring cannot be laid onto a concrete surface. Engineering hardwood floors have been proposed to alleviate some of the concerns related to placement on top of concrete floors. However, such engineered hardwood flooring often utilizes a plastic veneer surface that lacks the warmth and texture of real wood. Further, due to the nature of wood cutting devices, it is extremely difficult and time consuming to produce a wood flooring pattern that is not limited to use of individual planks having linear edges.

### SUMMARY OF THE INVENTION

Wooden tiles are disclosed having a top surface that is milled to produce multiple individual planks from a single individual tile. The tiles are configured such that when laid adjacent to one another on a surface, the pattern defined by the individual planks repeats. In one arrangement the tiles are milled on a CNC machine that allows for producing planks having non-linear edges.

According to a first aspect, a milled floor tile is disclosed. The floor tile includes a veneer layer disposed on a substrate layer. A plurality of grooves milled into the veneer define a plurality of individual planks in the top surface of the veneer. These grooves have a first cross-sectional profile. A rabbet cut that extends about a periphery of the upper edge of the veneer has a second cross-sectional profile that is one-half of the first cross-sectional profile. When disposed adjacent to a commonly configured tile, the two rabbet cuts collectively define a groove substantially identical to the groove in the veneer defining the planks.

According to a second aspect, a method for producing a milled floor tile is disclosed. The method includes providing a floor tile blank having an upper veneer and a lower substrate. The blank is positioned on a working surface of a three axis CNC machine. The CNC machine then cuts a plurality of grooves in the top surface of the veneer to define individual planks according to a predetermined pattern. The CNC is then operated to cut a peripheral edge of the tile and then create a rabbet cut about the periphery of the upper edge of the veneer.

According to another aspect, a floor tile and method for placement are provided for adherence to a concrete floor. The floor tile includes a veneer surface and a substrate. The substrate is formed of an exterior grade plywood that utilizes a moisture resistant glue to adhere its internal layers. Further a moisture resistant glue is utilized to adhere the tile to the concrete surface. The moisture resistant substrate and glue provide a sufficient moisture barrier to allow the direct adherence to the concrete surface.

### BRIEF DESCRIPTION OF THE DRAWINGS

FIGS. 1A-1D illustrate the hardwood laminate in milling of a channel groove into the laminate surface.

FIGS. 2A-2C illustrate milling an edged surface of a floor tile.

FIG. 3A illustrates a prospective view of a first embodiment of a milled floor tile.

FIG. 3B illustrates a top view of the milled floor tile of FIG. 3A.

FIG. 3C illustrates a cross sectional view of the milled floor tile of FIG. 3B.

FIG. 3D illustrates the interlocking of multiple ones of the milled floor tile of FIG. 3A.

FIGS. 4A-4C illustrate prospective, plan and side views of a second embodiment of a floor tile.

FIGS. 5A-5C illustrate prospective, plan and cross sectional views of a third embodiment of a milled floor tile.

FIGS. 6A-6C illustrate prospective, plan and cross sectional views of a fourth embodiment of a milled floor tile.

FIGS. 7A-7C illustrate prospective, plan and cross sectional views of another embodiment of the milled floor tile.

FIGS. 8A-8C illustrate prospective, plan and cross sectional views of another embodiment of the milled floor tile.

FIGS. 9A-9C illustrate prospective, plan and cross sectional views of another embodiment of the milled floor tile.

FIGS. 10A-10C illustrate prospective, plan and cross sectional views of another embodiment of the milled floor tile.

FIGS. 11A-11C illustrate prospective, plan and cross sectional views of another embodiment of the milled floor tile.

FIGS. 12A and 12B illustrate prospective and plan views of another embodiment of the milled floor tile.

FIGS. 13A and 13B illustrate a yet further embodiment of the milled floor tile.

### DETAILED DESCRIPTION

Reference will now be made to the accompanying drawings, which at least assist in illustrating the various pertinent features of the present invention. The following description is presented for purposes of illustration and description and is not intended to limit the invention to the form disclosed herein. Consequently, variations and modifications commensurate with the following teachings, and skill and knowledge of the relevant art, are within the scope of the present invention. The embodiments described herein are further intended to explain the best modes known of practicing the invention and to enable others skilled in the art to utilize the invention in such, or other embodiments and with various modifications required by the particular application(s) or use(s) of the present invention.

The present invention is directed to a wood flooring system that allows for providing an intricate design patterns including curved patterns without necessitating the individual production and placement of each plank of the wood pattern. Further, aspects of the present invention are directed to a wood flooring tile that allows for placement directly on concrete subfloors. Specifically, the present invention is directed to a milled floor tile that utilizes a finish quality wood laminate that is adhered to a surface of a multi-layered substrate (e.g., plywood). To provide the appearance of multiple individual tiles on each tile, channels or grooves are milled into the surface of the finish grade laminate to provide a desired pattern. Further, these channels are milled into the surface such that when disposed adjacent to an identical tile, the pattern defined by the grooves within the surface of the finish grade laminate are continuous. That is, the pattern continues from the first tile to the second tile. In this regard, when multiple tiles are laid on the floor, the pattern is repeating. In this regard, when disposed on a floor, the multiple tiles give the appearance of numerous individual wood planks that are laid onto the floor. Further, as the tiles are produced on a milling machine, non-linear patterns are readily produced.

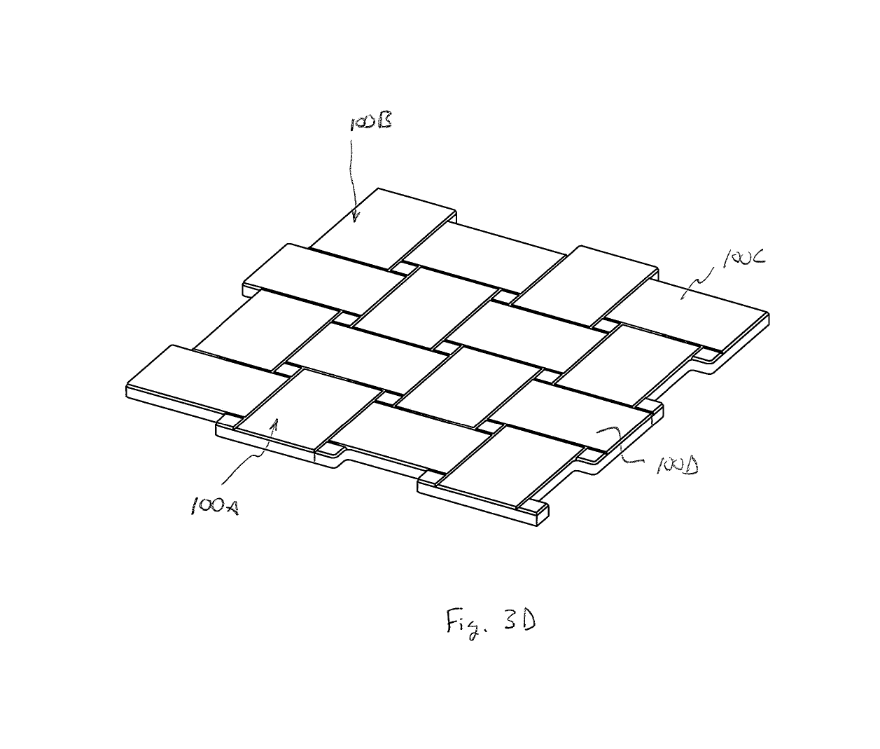

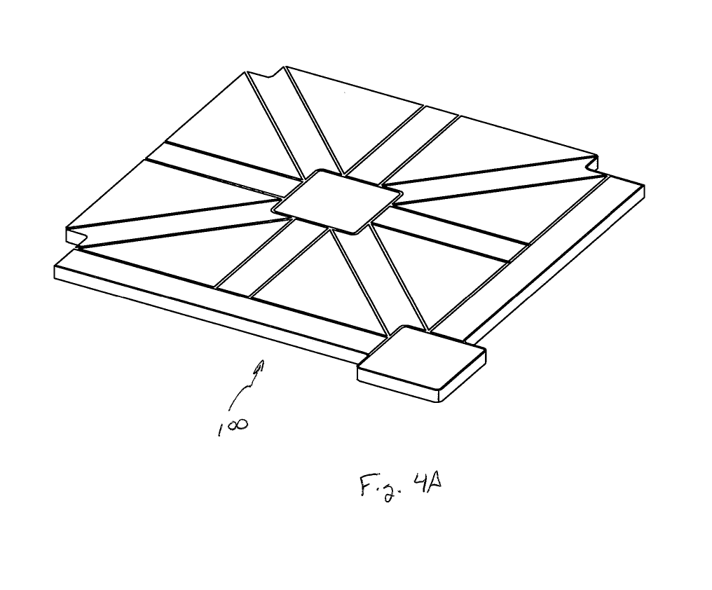

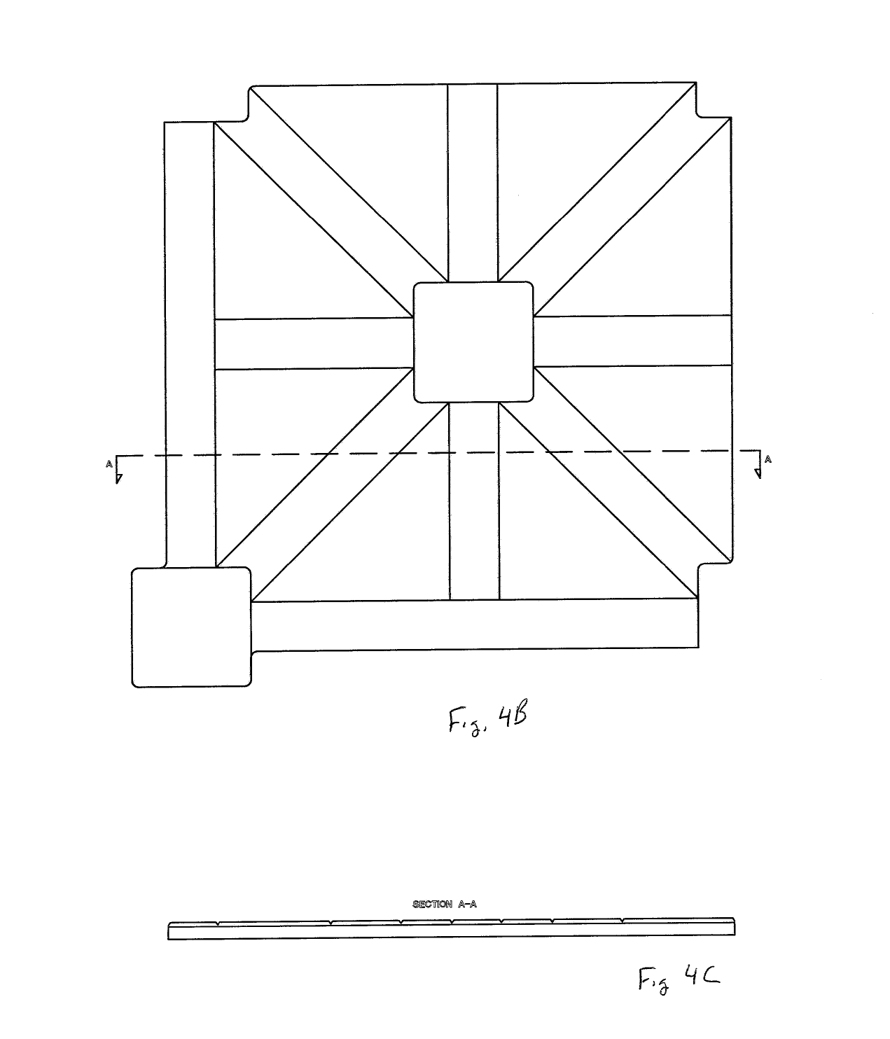

FIG. 3A illustrates a first embodiment of a milled floor tile in accordance with aspects of the present invention. As shown, the tile 100 includes a finish-quality veneer 110 that is disposed on top of a lower-quality substrate 120. In the present embodiment, the veneer is a solid wood sheet that is adhered to the top surface of the substrate 120. This veneer 110 is sometimes referred to as a lamel. In any case, the veneer 110 may be formed of a solid wood surface that allows for multiple sandings and finishings. In one embodiment, the veneer is a ¼″ plank of hardwood. However, it will be appreciated that other thicknesses are possible and within the scope of the present invention. The substrate 120 is formed of a lower-grade wood product than the veneer 110. Typically, the substrate is formed of a plywood that is made from thin sheets of wood that are glued together with adjacent plys having their grains at right angles to one another. However, it will be appreciated that other substrates are possible and within the scope of the present invention. In one particular embodiment, the substrate is formed of a ½″ Baltic birch plywood which itself is moisture resistant and which utilizes a water resistant or moisture resistant glue that laminates the various layers of the plywood together. This is sometimes referred to as exterior grade plywood. Use of such an exterior grade plywood allows for providing moisture resistance to the tile 100 which may allow for the tiles to be directly adhered to the surface of a concrete floor. Typically, when adhered to the surface of a concrete floor, a moisture resistant mortar or glue is utilized to adhere the tiles in place. The moisture resistance of the glue further provides moisture protection for the wooden surface of the veneer 110.

As shown in FIG. 3A, the surface of the tile 110 includes multiple channels or grooves 130 that are milled into its surface. These grooves 130 are recessed relative to the top surface of the veneer 110 as illustrated in FIG. 3C. Milling of the grooves 130 into the surface of the veneer 100 provides the impression that the singular floor tile 110 includes multiple individual wooden planks 140A-140H. In this regard, when the tile 100 is placed on a floor (laid), it gives the appearance of the placement (i.e., in the present embodiment) of eight individual planks of wood. As will be appreciated, provision of the multiple individual planks 140 on the surface of the veneer 110 allows for generating a complex design on a floor without the individual placement of multiple individual planks. Accordingly, this allows for laying a floor in significantly reduced time as opposed to the use of individual planks.

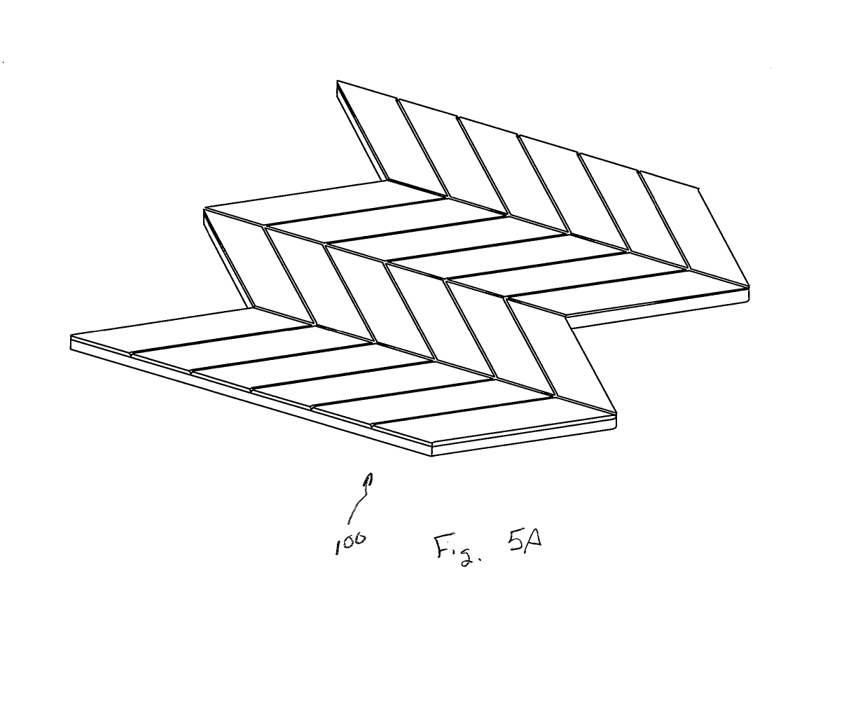

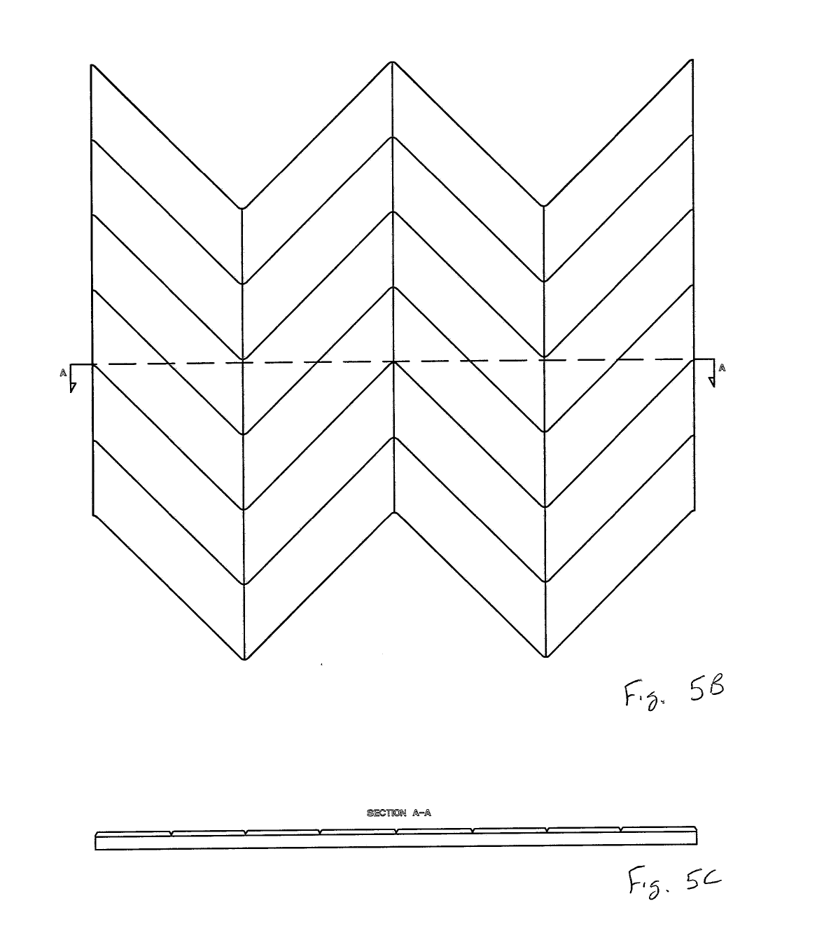

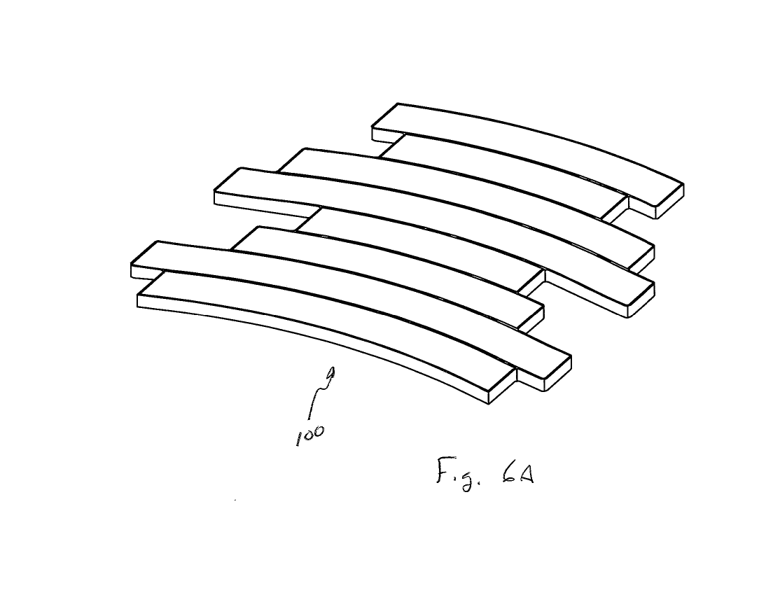

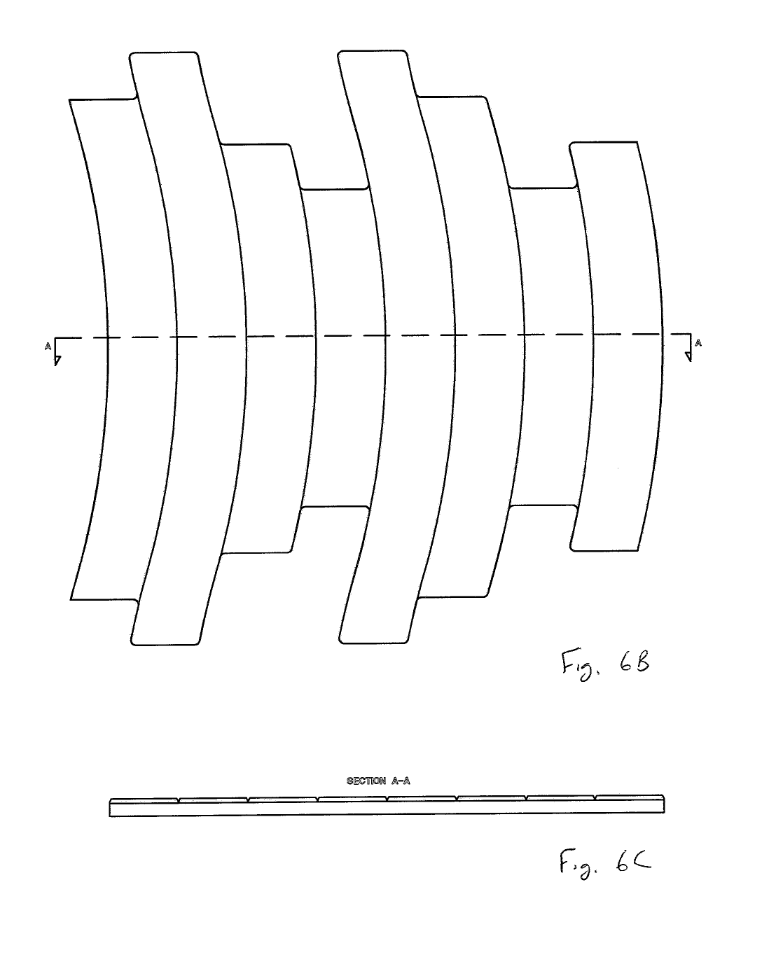

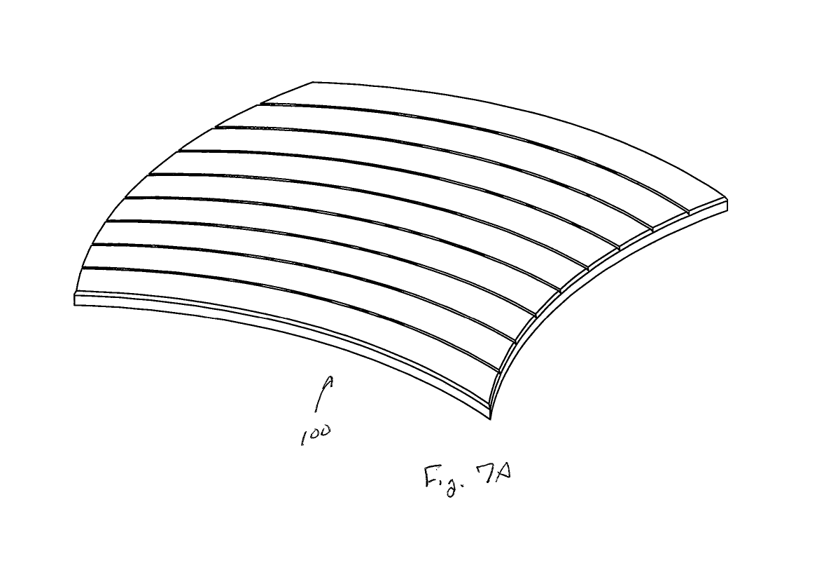

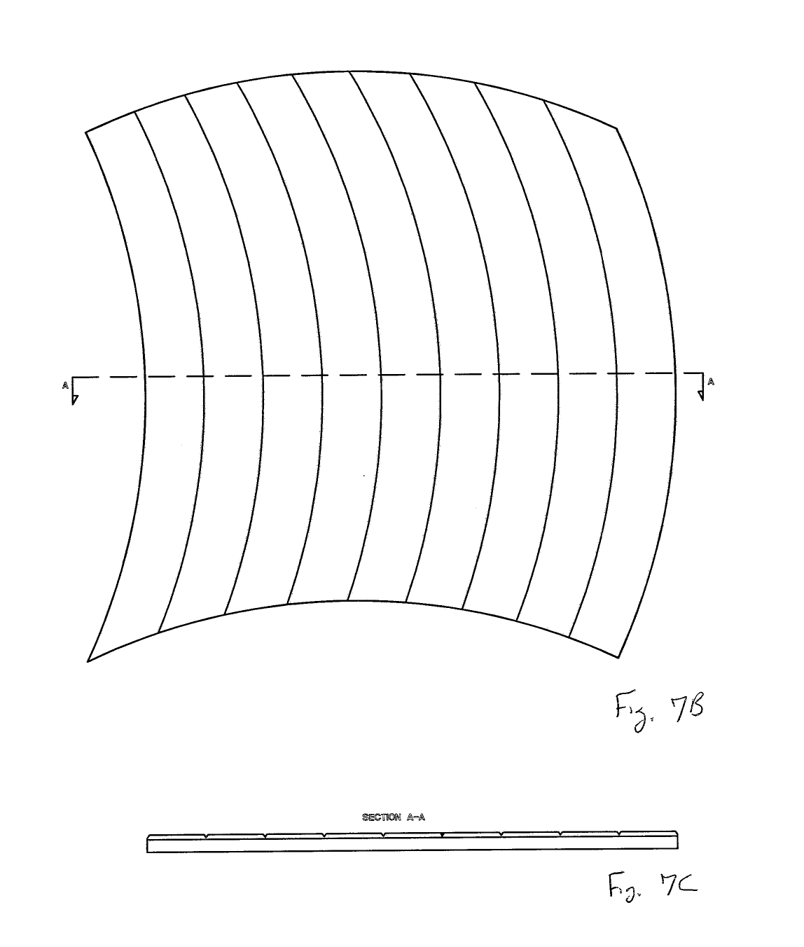

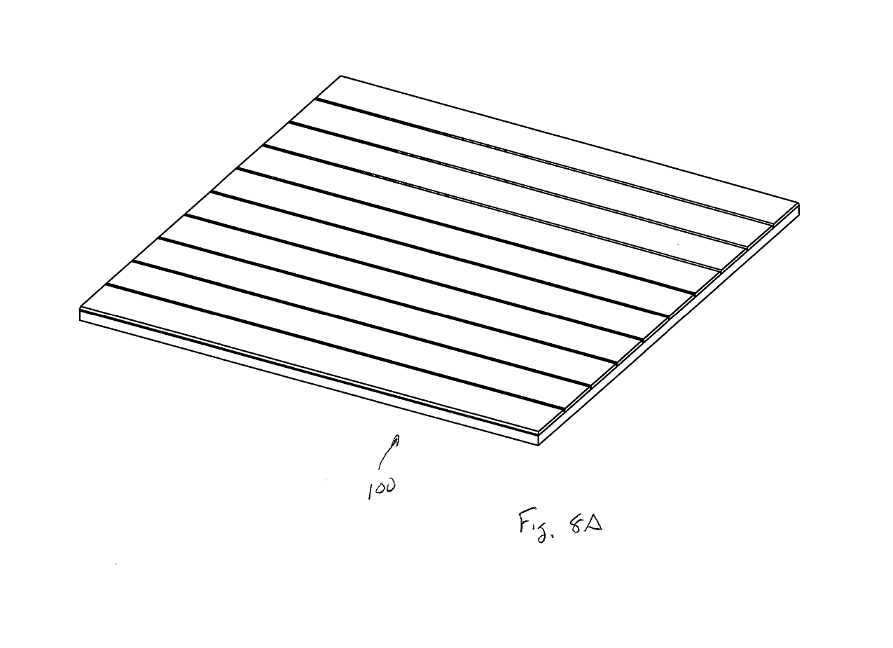

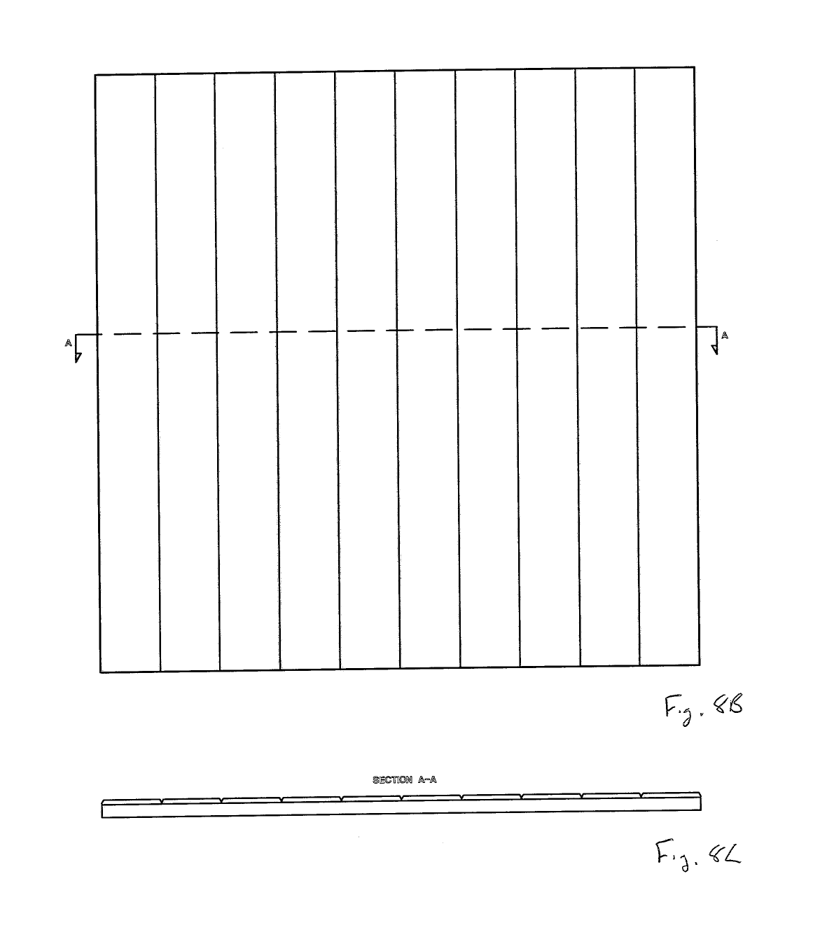

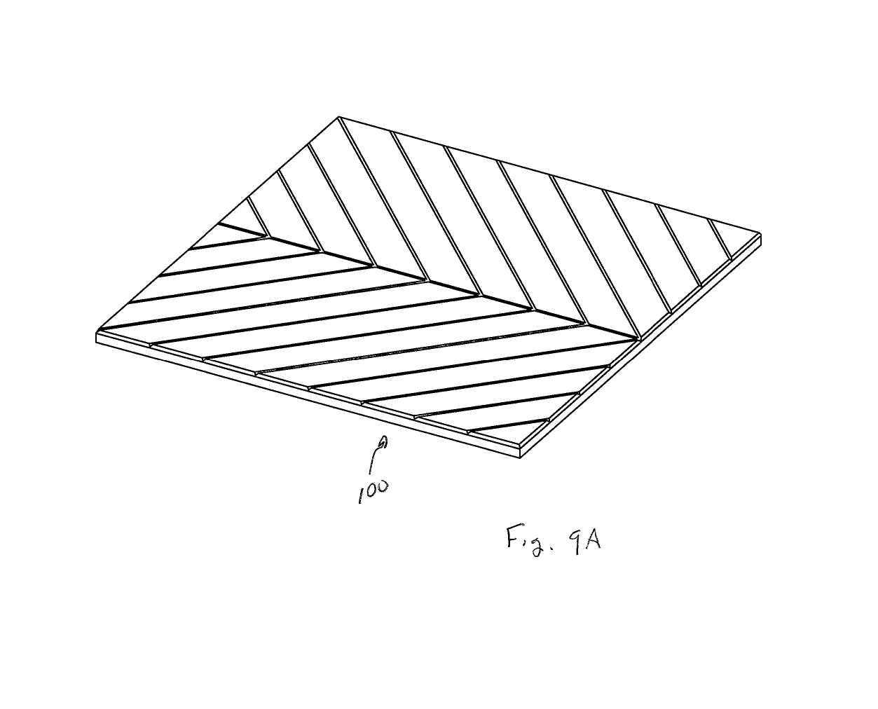

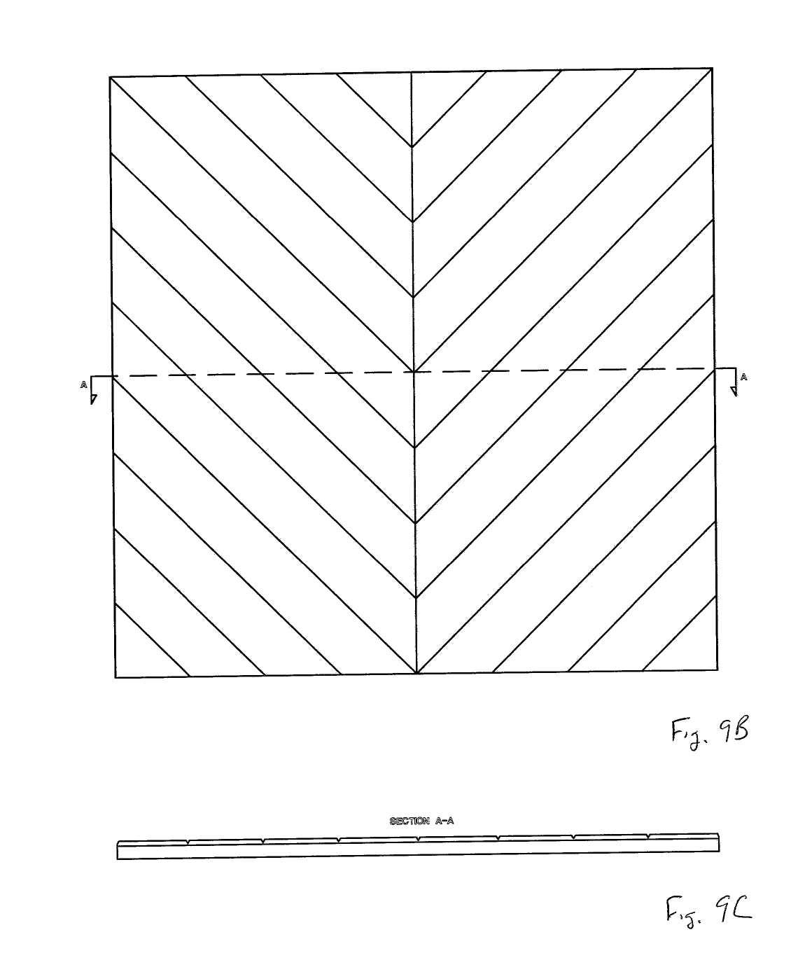

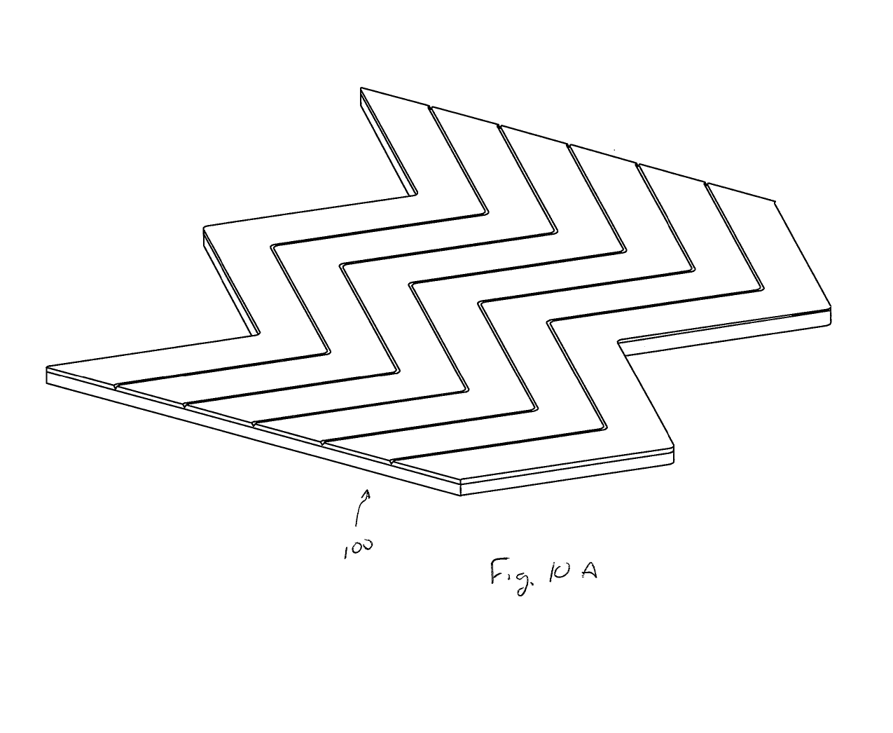

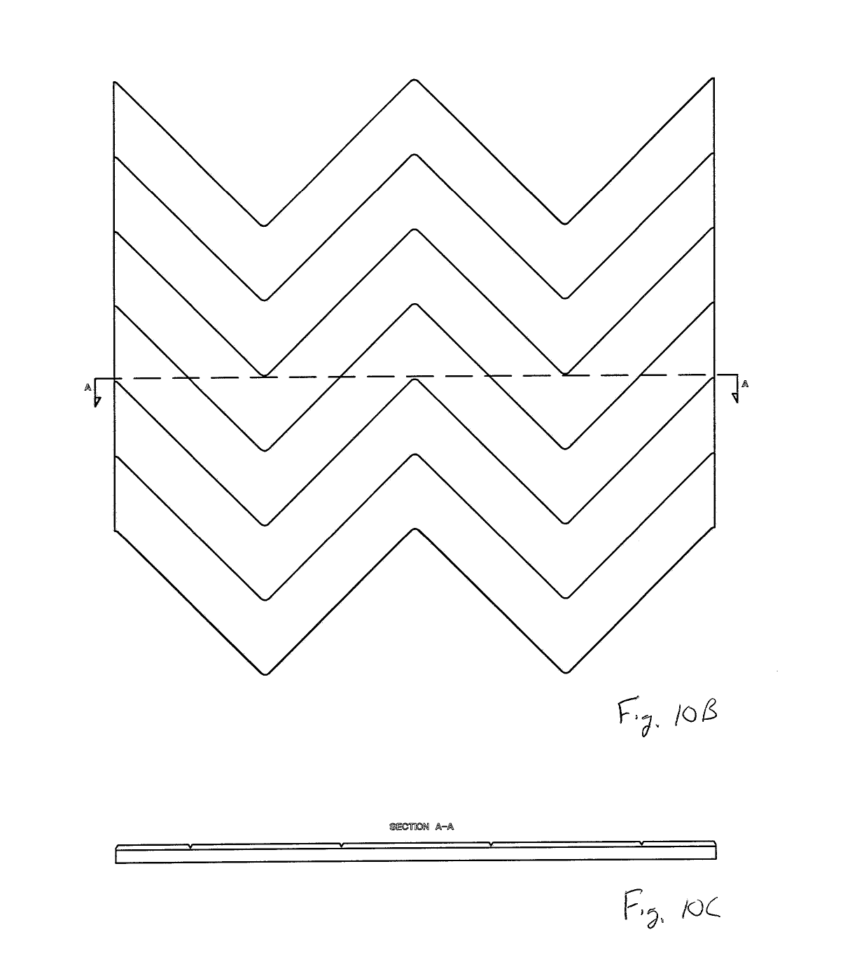

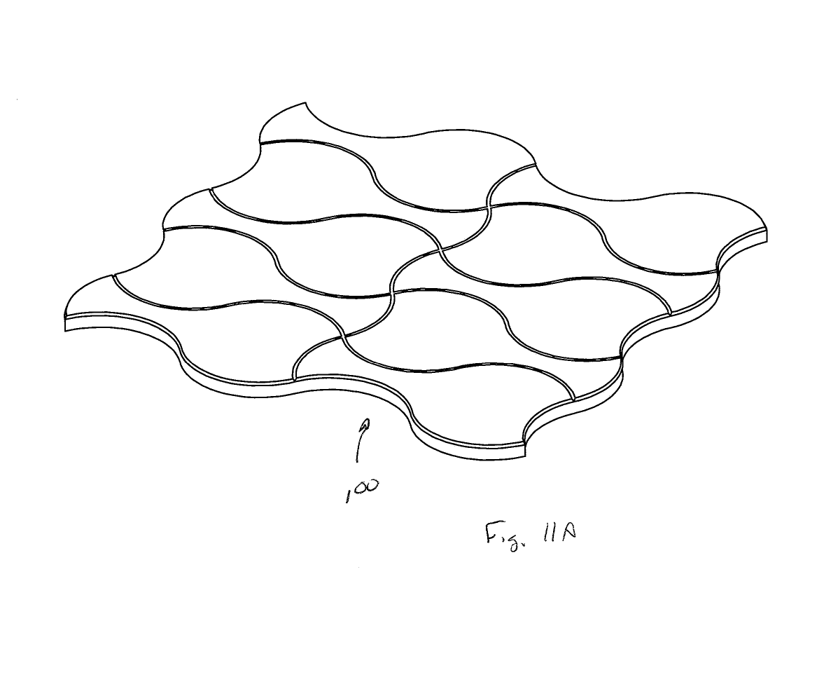

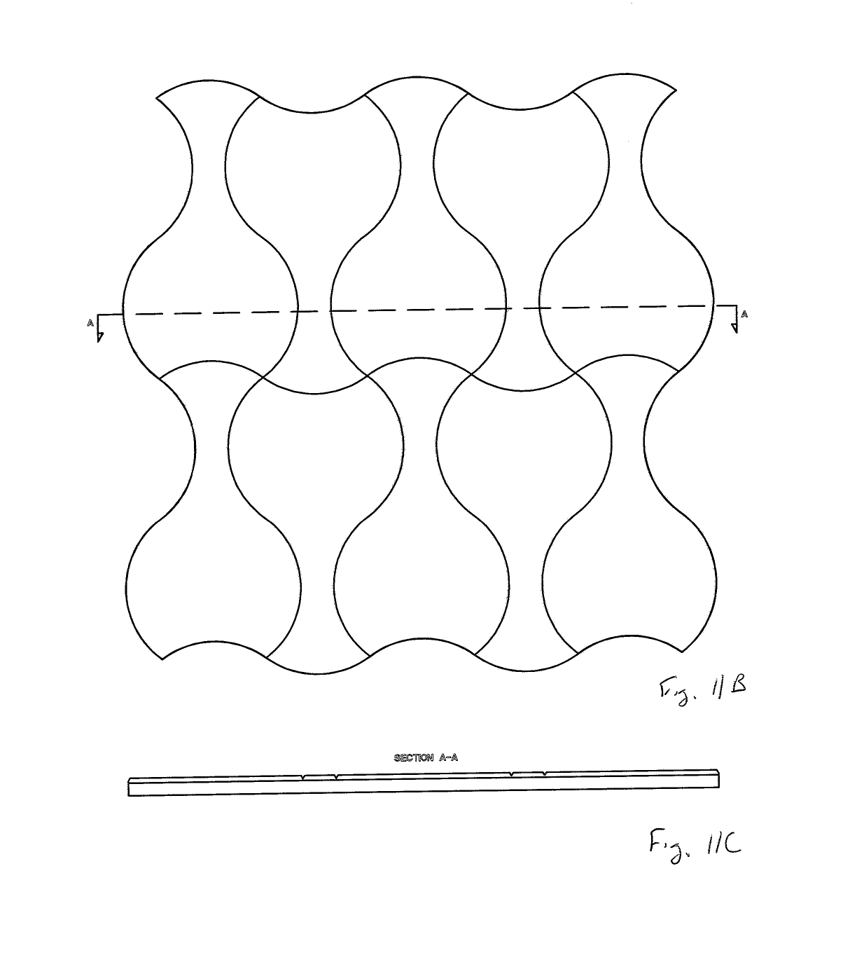

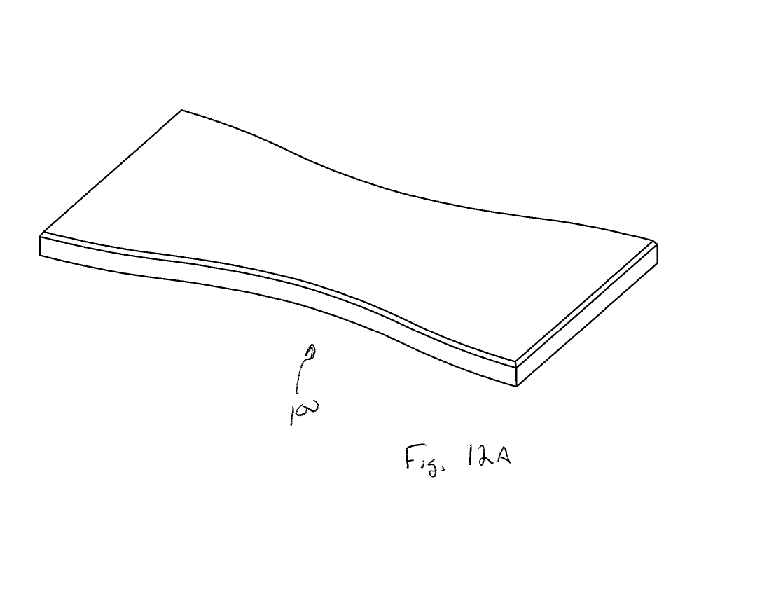

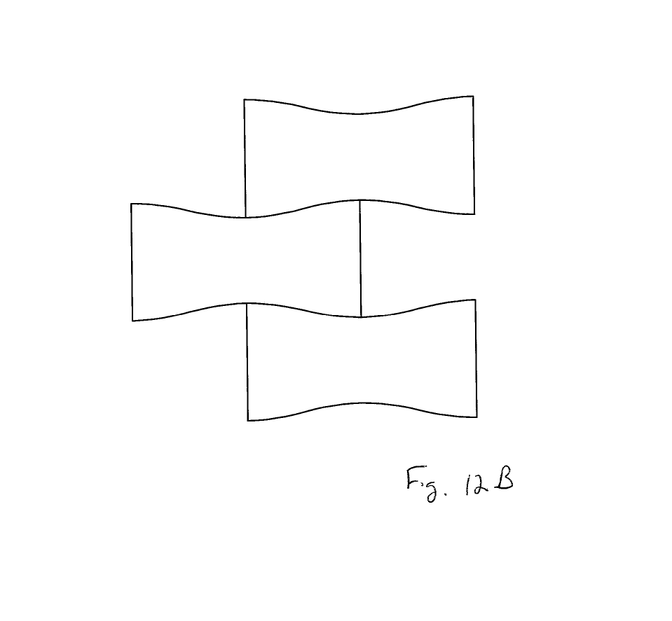

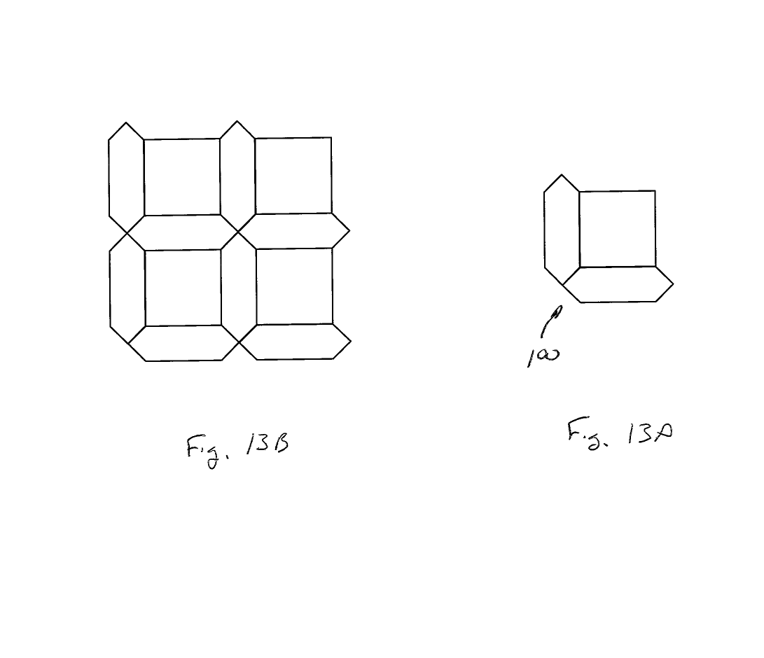

FIG. 3D illustrates the placement of four tiles 100A-100D in an adjacent position on a floor. As illustrated, the patterns defined by the channels 130 in the surface of the veneer 110 as shown in FIG. 3A are repeating between individual tiles 100A-100D such that the pattern formed by the channels on each tile 100 repeats throughout the adjacent tiles. In this regard, when laid on a floor, the seams of each individual tile blend into the pattern. That is, it appears that each individual plank 140A-140H is an individual plank that is laid on the floor. It will be appreciated that multiple individual patterns may be developed that allow for providing for a repeating pattern on a floor. Such multiple individual patterns are variously illustrated in FIGS. 4-13. However, additional patterns are possible and considered within the scope of the present invention.

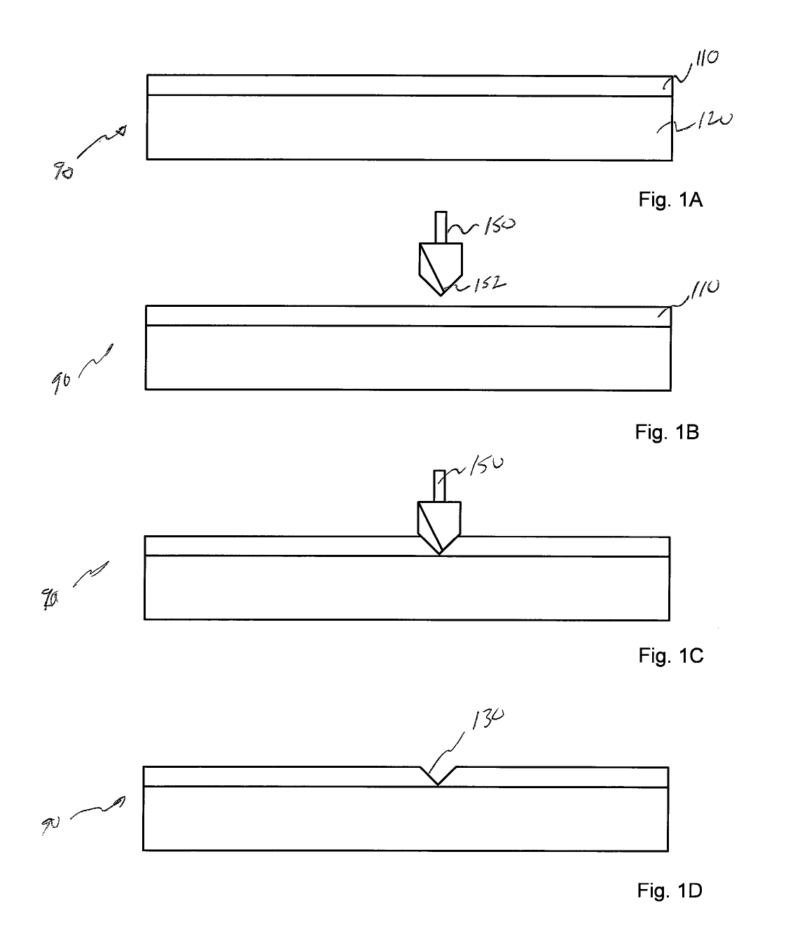

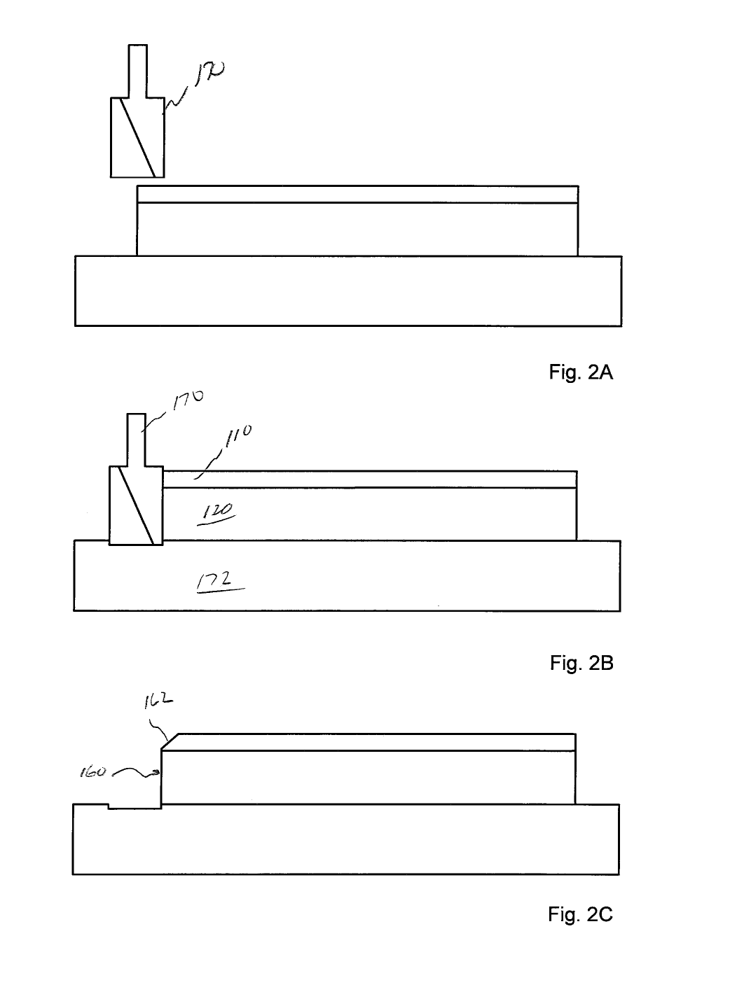

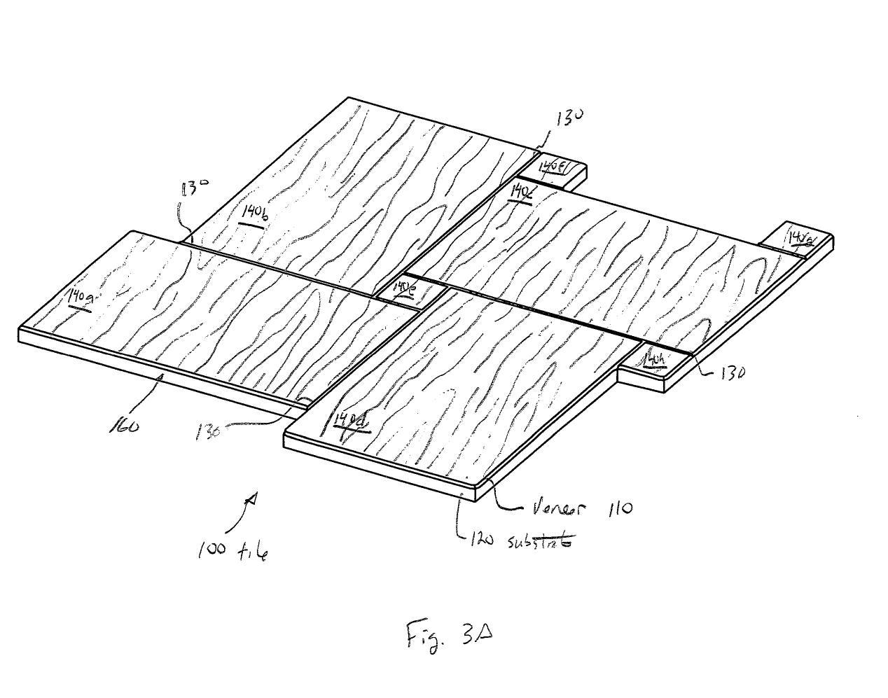

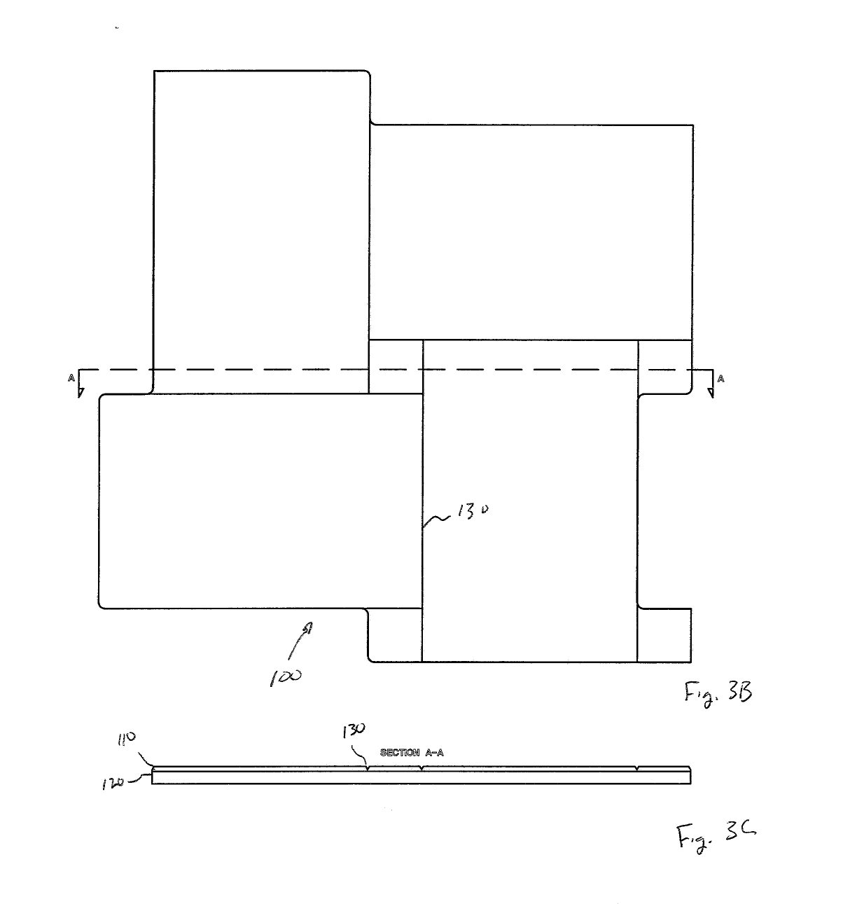

FIGS. 1 and 2 illustrate the manufacture of the milled floor tile 100. Initially, the veneer 110 is adhered to the top surface of a substrate 120 as illustrated in FIG. 1A. At this time, the veneer 110 and substrate 120 define a blank 90 that will be processed to produce the floor tile 100. As shown, the blank may have differing widths and lengths. For instance, the width of the blank may be between about three inches and about twenty-four inches. Likewise, the length of the blank (not shown) may be substantially equal to its width. However, it will be appreciated that in other embodiments, the length and width may be different. Once the laminate 110 is glued to the surface of the substrate 120, the blank is pressed while the glue adhering these elements 110, 120 cures. Once cured, the channels 130 of a desired pattern may be milled into the top surface of the veneer 110. In this regard, a three axis filling machine (i.e., CNC machine), may be utilized to mill the channels into the top surface of the veneer 110. In this regard, a bit 150 may be selected that has a desired cutting face 152.

The cutting face 152 is utilized to cut into the surface of the veneer 110 as illustrated in FIGS. 1B and 1C. Though illustrated as utilizing a generally v-shaped cutting face 152 (e.g., cross-sectional profile), other configurations may be utilized. For instance, the angle may be adjusted, rounded, or square. In any case, the bit 150 is inserted into the CNC machine which is programmed to cut a desired pattern of the surface of the laminate 110. As will be appreciated, such CNC machines are operative to identify the location of a blank 90 and thereafter cut a preprogrammed pattern into the surface. Further, the CNC may take several passes to generate the groove 130 as illustrated in FIG. 1D.

Once the channels or grooves 130 are formed into the surface of the blank 90, the edge pattern of the tile 100 may be milled according to a predetermined pattern. Referring briefly to FIG. 3, it is noted that the edge pattern of the tile 100 is non-uniform. That is, rather than being a simple square (see, for example, FIG. 9A) the outside edge 160 of the tile 100 as shown in FIG. 3 must be cut to the desired pattern having one or more non-linear edges that mate with an adjacent tile. This is illustrated in FIG. 2A. As shown in FIG. 2B, a plow bit 170 extends through the entirety of the blank 90 through both the veneer 110 and substrate 120 to cut the desired edge. The bit 170 generally extends into a waste board 172 that is disposed below the blank 90. Once the edge is cut, the outside shape of the tile 100 is defined.

In order for adjacent tiles to match up when disposed adjacent to one another, it is also desirable to provide a rabbet cut on the top outside edge of the laminate 110. This rabbet cut 162 is illustrated in FIG. 2C. In the present embodiment, the rabbet cut 162 has a cross-sectional profile is that is one-half of the cross sectional profile of the grooves 130 that are cut into the top surface of the veneer 110 to define the individual planks on the tile. Accordingly, when this rabbet cut is placed adjacent to another rabbet cut of an adjacent tile, the resulting cross-sectional profile of these two rabbet cuts matches the cross-sectional profile of the grooves 130 in the remainder of the tiles. In this regard, the seam between adjacent tiles is substantially invisible.

The foregoing description has been presented for purposes of illustration and description. Furthermore, the description is not intended to limit the inventions and/or aspects of the inventions to the forms disclosed herein. For instance, though not illustrated with wood grain in each of the figures, it will be appreciated that each of the tiles has a wood surface. Consequently, variations and modifications commensurate with the above teachings, and skill and knowledge of the relevant art, are within the scope of the presented inventions. The embodiments described hereinabove are further intended to explain best modes known of practicing the inventions and to enable others skilled in the art to utilize the inventions in such, or other embodiments and with various modifications required by the particular application(s) or use(s) of the presented inventions. It is intended that the appended claims be construed to include alternative embodiments to the extent permitted by the prior art.

What is claimed is:

1. A floor tile comprising:
a substrate layer;
a veneer layer of finish grade wood , wherein a bottom surface of said veneer layer is fixedly attached to a top surface of said substrate layer;
a plurality of grooves milled into a top layer of said veneer layer, wherein said grooves have a common first cross-sectional profile and define a plurality of individual planks in said top surface and wherein, said individual planks form a repeating pattern when disposed adjacent to one or more commonly configured floor tiles; and
a rabbet cut about an outside periphery of said veneer layer, wherein a second cross-sectional profile of said rabbet cut is substantially identical to one half of the first cross-sectional profile of the grooves.

2. The floor tile of claim 1, wherein said substrate layer comprises a plywood layer.

3. The floor tile of claim 1, wherein said veneer layer comprises a hardwood layer.

4. The floor tile of claim 1, wherein, a third cross-sectional profile defined by rabbet cuts of adjacent tiles is substantially identical to the first cross-sectional profile.

5. The floor tile of claim 1, wherein said grooves extend through at least one-half of the thickness of the veneer layer.

6. The floor tile of claim 1, wherein at least two peripheral edges of said floor tile are non-linear.

7. The floor tile of claim 6, wherein said non-linear peripheral edges are adapted to engage a mating edge of a commonly configured floor tile.

8. The floor tile of claim 1, wherein said grooves are curves along their length.

9. A method for producing a wooden floor tile, comprising:
providing a floor tile blank having an upper veneer layer and a lower substrate layer;
positioning the floor tile blank on a working surface of a CNC milling machine;
using said CNC milling machine, cutting a plurality of grooves in said veneer layer according to a predetermined groove pattern, wherein the grooves have a common first cross-sectional profile and define a plurality of individual plank in said veneer layer, wherein said grooves extend through a portion of said veneer layer;
using said CNC milling machine, cutting a peripheral edge of said floor tile according to a predetermined edge pattern, wherein said peripheral edge extends through said upper veneer layer and said lower substrate layer; and
using said CNC milling machine, cutting a rabbet on an upper peripheral edge of said veneer layer after cutting said peripheral edge, wherein a second cross-sectional profile of said rabbet cut is substantially identical to one half of the first cross-sectional profile of the grooves.

10. The method of claim 9, further comprising:
cutting a plurality of curved grooves to define said plurality of individual planks having curved edges.

11. The method of claim 9, wherein cutting said peripheral edge comprises cutting at least first and second non-linear edges.
